(19) United States
(12) Patent Application Publication
(10) Pub. No.: US 2022/0053753 A1
(43) Pub. Date: Feb. 24, 2022

(54) A Device for Repelling Aquatic Organisms that cause Human Harm or Feeding Damage and Method for Using the Device

(71) Applicant: HANAZONO CO., LTD., Midori-ku, Saitama-shi Saitama (JP)

(72) Inventor: Satoshi Nagoya, (US)

(73) Assignee: HANAZONO CO., LTD., Midori-ku, Saitama-shi Saitama (JP)

(21) Appl. No.: 17/309,930

(22) PCT Filed: Jan. 5, 2020
(86) PCT No.: PCT/JP2020/000006

§ 371 Date: Jul. 1, 2021

(30) Foreign Application Priority Data
Jan. 7, 2019 (JP) 2019-000424
Dec. 29, 2019 (JP) 2019-240001

(51) Int. Cl. A01M 29/24; A01M 29/10

(52) U.S. Cl. CPC A01M 29/24; A01M 29/10

(57) ABSTRACT

In a device for repelling organisms causing human damage such as sharks, a tubular member made of a viscoelastic material and a part of the tubular member are provided. A voltage is applied between the built-in power supply device, electrodes provided on a part or all of the outer surface of the tubular member, a string-shaped member having a counter electrode extending from the tubular member, and the electrodes. A switch that turns on and off the energization from the power supply device for power supply, and a joint member that connects the tubular members in a ring shape, and by putting them in water and applying a voltage between the electrodes, sharks that live in water, etc.

### CROSS-REFERENCES TO RELATED APPLICATIONS

This Non-Provisional Utility Patent Application is a U.S. National Stage application that claims the benefit of and priority to International Application Serial No. PCT/JP2020/000006, entitled “Device for Repelling Aquatic Organisms that cause Human Casualties or Feeding Damage such as Sharks, and Method for Using Device,” filed Jan. 6, 2020, which claims the benefit of and priority to Japanese Patent Application Serial No. 2019-000424, Filed Jan. 7, 2019, the entire contents of each application of which is hereby incorporated herein by reference.

### BACKGROUND

### Field of the Invention

The present invention relates to a device for repelling organisms that cause human damage or feeding damage such as sharks living in water and a method for using the same.

### Background Technology

When fishing for fish such as tuna, feeding damage by sharks etc. was very frequent and was a problem. Even in fishing as a leisure activity, eating damage caused by sharks and the like has been a cause of diminishing interest and reducing its value. In addition, human damage caused by sharks during marine leisure such as surfing was enormous, and countermeasures were required.

On the other hand, various measures against feeding damage have been taken in the fishery field. Fish, especially cartilaginous fish such as sharks, which have a high frequency of feeding damage, have a sensory organ in the head that senses an electric current, which is used to help capture the predator. However, since it has such an organ, it is very sensitive to electric current, and a repellent device using this has been proposed.

For example, in tuna single fishing, etc., a device for electric shock that is pre-equipped on the road thread is used, and when the tuna hits the needle, it is thrown in, and the electric shock of several hundred volts is applied by the power supply from the ship to add the tuna. It is being done to stop the activities of tuna and prevent tuna and other feeding damage.

### PRIOR ART DOCUMENT

[Patent Document 1] JP2006-149275

[Patent Document 2] JP2013-169170

### SUMMARY

In a device for repelling organisms causing human damage such as sharks, a tubular member made of a viscoelastic material and a part of the tubular member are provided. A voltage is applied between the built-in power supply device, electrodes provided on a part or all of the outer surface of the tubular member, a string-shaped member having a counter electrode extending from the tubular member, and the electrodes. A switch that turns on and off the energization from the power supply device for power supply, and a joint member that connects the tubular members in a ring shape, and by putting them in water and applying a voltage between the electrodes, sharks that live in water, etc.

### DETAILED DESCRIPTION

### Overview

However, in the case of fishing as a leisure activity, not only is it almost impossible to prepare an electric shock device as described above, but there is also the danger of using a high voltage in seawater, so it was not generally used.

Similarly, measures that do not use high voltage are being considered. Patent Document 1 or Patent Document 2 discloses a feeding damage repellent device for fisheries. Patent Document 1 discloses a method of repelling a shark by an electric current in longline fishing, and Patent Document 2 provides electrodes at both ends of a balance and incorporates a power supply (battery) in a weight to pass an electric current to the shark. A mode of avoiding feeding damage such as is disclosed.

However, there was no device that could be used for leisure fishing with a simple configuration and could avoid feeding damage when fishing for fish such as tuna, and there was a great need for this.

Furthermore, there is no device that can be used during marine leisure such as surfing with a simple configuration and can avoid human damage caused by sharks and the like. Such a device is effective for protecting human life, and the effect is very large.

### Means for Solving Problems

The present invention is a device that repels organisms that cause human damage or feeding damage such as sharks that live in water, and is provided on a tubular member made of a viscoelastic material and a part of the tubular member. A built-in power supply device, an electrode provided on a part or all of the outer surface of the tubular member, a string-shaped member having a counter electrode extending from the tubular member, and energization from the power supply device. A switch that turns on and off and a joint member that connects the tubular member in a ring shape are provided, and by throwing it into water and applying a voltage and/or current between the electrodes, human damage such as sharks living in water or human damage or It is a device that repels organisms that cause feeding damage, and how to use it.

Further, the present invention is provided in a device for repelling organisms that cause human damage or feeding damage such as sharks living in water, in which a tubular member made of a viscoelastic material and a part of the tubular member are provided. Alternatively, a built-in power supply device, an electrode provided on a part of the outer surface of the tubular member, a counter electrode provided on another part of the outer surface of the tubular member, and energization from the power supply device are applied. A switch that turns on and off and a joint member that connects the tubular member in a ring shape are provided, and by throwing it into water and applying a voltage and/or current between the electrodes, human damage such as sharks living in water or human damage or It is a device that repels organisms that cause feeding damage, and how to use it.

Further, in the present invention, when the device is used to avoid feeding damage when fishing fish such as tuna, the device is stored on the ship in a state where the switch is off and the joint member is not connected. After the fish to be fished such as tuna is caught on the needle, the tube-shaped member is connected by a ring-shaped joint member so as to surround the thread, and the thread is used as a guide to throw the fish into the vicinity of the fish to be fished. To do.

Further, in the present invention, as a material having viscoelasticity used for the tubular member, synthetic resin, silicon resin, natural rubber, synthetic rubber, phenol resin, epoxy resin, melamine resin, urea resin, unsaturated polyester resin, alkyd resin, etc. Thermosetting resins such as polyurethane and thermosetting polyimide, polyethylene, polypropylene, polyvinyl chloride, polyvinylidene chloride, polystyrene, vinyl acetate, polytetrafluoroethylene, ABS resin, AS resin, acrylic resin, polyamide, nylon, polyacetal □E Polycarbonate □E Modified polyphenylene ether □E Polybutylene terephthalate □E Polyethylene terephthalate □E Cyclic polyolefin □E Polyphenylensulfide □E Polytetrafluoroethylene □E Polysulfone □E Polyether sulfone □E Acrylic polyarylate □E Liquid crystal polymer □E Polyether ether ketone □E Thermoplastic polyimide □Elt is characterized by being any one of a thermoplastic resin such as polyamideimide, a mixed material thereof, a composite material of these and a fiber, a glass fiber, and other reinforcing materials, and a composite material including a metal material.

Further, the present invention is characterized in that the size of the ring in a state where the tubular members are connected in a ring shape is 10 cm or more and 60 cm or less. Further, in the present invention, it is desirable that the size of the ring in a state where the tubular members are connected in a ring shape is 15 cm or more and 40 cm or less.

Further, the present invention is characterized in that the joint for connecting the tubular members has a structure in which both ends are fitted to each other. Further, in the present invention, a one-touch joint is preferably used as a joint for connecting the tubular members.

Further, the present invention is characterized in that the joint for connecting the tubular members has a structure of joining with a magnet. Further, in the present invention, a neodymium magnet is preferably used as the magnet used for the joint for connecting the tubular members.

Further, the present invention is characterized in that the length of the string-shaped member provided with the counter electrode extending from the tubular member is 30 cm or more and 3 m or less. Further, in the present invention, it is desirable that the length of the string-shaped member provided with the counter electrode extending from the tubular member is 50 cm or more and 2 m or less.

Further, the present invention is characterized in that the power supply device for applying a voltage between the electrodes includes a battery. Further, in the present invention, a dry battery, a button type battery or a rechargeable storage battery is preferably used as the battery.

Further, the present invention is characterized in that the power supply device included in the device prepares a discharge voltage and discharges it into the sea in order to control an electromagnetic field in water. Further, the present invention is characterized in that the discharge voltage discharged into the sea is a pulse voltage.

Further, the present invention is characterized in that the power supply device included in the device outputs a discharge current into the sea in order to control the electromagnetic field in water. Further, the present invention is characterized in that the discharge voltage discharged into the sea is a pulse current.

Further, the present invention is characterized in that the pattern of the discharge voltage or discharge current discharged into the sea can be changed. Further, the present invention is characterized in that the pattern of the discharge voltage or discharge current discharged in the sea can be changed, and the pattern can be changed in the field at the time of use.

Further, the present invention is characterized in that the pattern changing function is performed by incorporating a function that can be reprogrammed.

Further, the present invention is characterized in that the pattern changing function is performed by installing programmable hardware.

Further, the present invention is characterized in that the pattern changing function is performed by mounting a microcomputer and recorded software and rewriting the program.

The present invention is also characterized in that the discharge voltage or discharge current discharged in the sea is generated by a charge pump or a DC-DC converter. Alternatively, the present invention is characterized in that the pulse width and/or period of the pattern of the discharge voltage or discharge current discharged into the sea is controlled.

Further, the present invention is characterized in that the pulse width and/or period of the pattern of the discharge voltage or discharge current discharged into the sea can be changed.

The present invention is also characterized in that the pattern of the discharge voltage or discharge current discharged into the sea is randomly changed in its pulse width and/or period.

The present invention is also characterized in that the pattern of the discharge voltage or discharge current discharged into the sea has a pulse width of 0.2 seconds or more and 0.7 seconds or less. Further, in the present invention, it is desirable that the period of the pattern of the discharge voltage or the discharge current discharged into the sea is 0.5 seconds or more and 5 seconds or less, and twice or more the discharge pulse width. It is more desirable that the period of the pattern of the discharge voltage or discharge current discharged into the sea is 1 second or more and 4 seconds or less, and twice or more the discharge pulse width.

Further, the present invention is characterized in that the tubular member has translucency, a light emitting element is provided on the circuit, and the internal state can be confirmed by the light emission of the light emitting element. An LED element is preferably used as the light emitting element. Further, the present invention is characterized in that the light emitting element is an LED element and also has a function of notifying the position in an emergency.

Further, the present invention is characterized in that the voltage supplied by the power supply device is 3 V or more and 30 V or less.

Further, the present invention is characterized in that the pulse voltage or pulse current supplied by the power supply device is set so as to also serve as a signal for notifying the position in an emergency. Further, the present invention is characterized in that the pulse voltage or pulse current supplied by the power supply device for applying a voltage between the electrodes is set so as to also serve as a Morse code.

Further, the present invention has a configuration in which a switch for turning on/off the energization from a power supply device for applying a voltage between the electrodes is turned on by connecting a joint for connecting the tubular members. It is a feature.

Further, the present invention is characterized in that a switch for turning on/off the energization from the power supply device for applying a voltage between the electrodes is configured so that the sensor reacts and turns on when the switch is put into water.

Further, in the present invention, when the device is used to avoid feeding damage when fishing fish such as tuna, the main body in which the tubular members are connected in a ring shape is fitted into the head of the target fish after being put into the gill lid. It is characterized by restricting the movement of the target fish and regulating the activity of the target fish.

Further, in the present invention, when the device is used to avoid human damage caused by sharks during marine leisure such as surfing, diving, snorkeling, etc., the device is attached to a user's arm, leg, etc. It is characterized in that it is attached to equipment such as a wet suit or installed on equipment such as a surfboard.

The present invention is a device that repels organisms that cause human damage or feeding damage such as sharks that live in water, and is a power supply device enclosed in a waterproof member and one of the outer surfaces of the waterproof member. It is equipped with a string-shaped member having an electrode provided in a part or all of it, a counter electrode extending from the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

Further, the present invention is a device for repelling organisms that cause human damage or feeding damage such as sharks living in water, in which a power supply device enclosed in a waterproof member and an outer surface of the waterproof member are used. It is equipped with an electrode provided in a part, a counter electrode provided in another part of the outer surface of the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

Further, the present invention is a device for repelling an organism that causes human damage or feeding damage such as a shark that lives in water. The power supply device is sealed with a molding agent, and even when it is put into water, it is contained in water. It is characterized by not touching.

Further, in the present invention, as a material having viscoelasticity used for the tubular member, synthetic resin, silicon resin, natural rubber, synthetic rubber, phenol resin, epoxy resin, melamine resin, urea resin, unsaturated polyester resin, alkyd resin, etc. Thermosetting resins such as polyurethane and thermosetting polyimide, polyethylene, polypropylene, polyvinyl chloride, polyvinylidene chloride, polystyrene, vinyl acetate, polytetrafluoroethylene, ABS resin, AS resin, acrylic resin, polyamide, nylon, polyacetal □E Polycarbonate □E Modified polyphenylene ether □E Polybutylene terephthalate □E Polyethylene terephthalate □E Cyclic polyolefin □E Polyphenylensulfide □E Polytetrafluoroethylene □E Polysulfone □E Polyether sulfone □E Acrylic polyarylate □E Liquid crystal polymer □E Polyether ether ketone □E Thermoplastic polyimide □EIt is characterized by being any one of a thermoplastic resin such as polyamideimide, a mixed material thereof, a composite material of these and a fiber, a glass fiber, and other reinforcing materials, and a composite material including a metal material.

Further, the present invention is characterized in that the molding agent is injected and formed so as not to leave air bubbles or voids between the molding agent and the power supply device enclosed inside.

Further, the present invention is characterized in that the material used for the waterproof member is formed by injection molding.

Further, the present invention is characterized in that the length of the string-shaped member provided with the counter electrode extending from the tubular member is 30 cm or more and 3 m or less. Further, in the present invention, it is desirable that the length of the string-shaped member provided with the counter electrode extending from the tubular member is 50 cm or more and 2 m or less.

Further, the present invention is characterized in that the power supply device for applying a voltage between the electrodes includes a battery. Further, in the present invention, a dry battery, a button type battery or a rechargeable storage battery is preferably used as the battery.

Further, the present invention is characterized in that the power supply device included in the device prepares a discharge voltage and discharges it into the sea in order to control an electromagnetic field in water. Further, the present invention is characterized in that the discharge voltage discharged into the sea is a pulse voltage.

Further, the present invention is characterized in that the power supply device included in the device outputs a discharge current into the sea in order to control the electromagnetic field in water. Further, the present invention is characterized in that the discharge voltage discharged into the sea is a pulse current.

Further, the present invention is characterized in that the pattern of the discharge voltage or discharge current discharged into the sea can be changed. Further, the present invention is characterized in that the pattern of the discharge voltage or discharge current discharged in the sea can be changed, and the pattern can be changed in the field at the time of use.

Further, the present invention is characterized in that the pattern changing function is performed by incorporating a function that can be reprogrammed.

Further, the present invention is characterized in that the pattern changing function is performed by installing programmable hardware.

Further, the present invention is characterized in that the pattern changing function is performed by mounting a microcomputer and recorded software and rewriting the program.

The present invention is also characterized in that the discharge voltage or discharge current discharged in the sea is generated by a charge pump or a DC-DC converter. Alternatively, the present invention is characterized in that the pulse width and/or period of the pattern of the discharge voltage or discharge current discharged into the sea is controlled.

Further, the present invention is characterized in that the pulse width and/or period of the pattern of the discharge voltage or discharge current discharged into the sea can be changed.

The present invention is also characterized in that the pattern of the discharge voltage or discharge current discharged into the sea is randomly changed in its pulse width and/or period.

The present invention is also characterized in that the pattern of the discharge voltage or discharge current discharged into the sea has a pulse width of 0.2 seconds or more and 0.7 seconds or less. Further, in the present invention, it is desirable that the period of the pattern of the discharge voltage or the discharge current discharged into the sea is 0.5 seconds or more and 5 seconds or less, and twice or more the discharge pulse width. It is more desirable that the period of the pattern of the discharge voltage or discharge current discharged into the sea is 1 second or more and 4 seconds or less, and twice or more the discharge pulse width.

Further, the present invention is characterized in that the pulse voltage or pulse current supplied by the power supply device is set so as to also serve as a signal for notifying the position in an emergency. Further, the present invention is characterized in that the pulse voltage or pulse current supplied by the power supply device for applying a voltage between the electrodes is set so as to also serve as a Morse code.

Further, the present invention is characterized in that the switch for turning on/off the energization from the power supply device has a configuration in which the sensor reacts and turns on when the switch is put into water.

Further, in the present invention, when the device is used to avoid human damage caused by sharks during marine leisure such as surfing, diving, snorkeling, etc., the device is attached to a user's arm, leg, etc. It is characterized in that it is attached to equipment such as a wet suit or installed on equipment such as a surfboard.

Further, the present invention is characterized in that the waterproof member and the mold member have translucency, and a light emitting element is provided on the circuit, and the internal state can be confirmed by the light emission of the light emitting element. . . . An LED element is preferably used as the light emitting element. Further, the present invention is characterized in that the light emitting element is an LED element and also has a function of notifying the position in an emergency.

Further, in the present invention, the waterproof member has a substantially cylindrical shape with one end formed into a substantially dome shape, and is used together with fishing gear, fishing gear, etc., or for a body, wet suit, life jacket, marine leisure equipment, etc. It is characterized by being attached and used. Further, the present invention is characterized in that the waterproof member is formed in a disk shape and has a belt, and is worn and used like a wristwatch during marine leisure.

The device and its usage method for repelling organisms that cause human damage or feeding damage such as sharks living in water according to the present invention can be used in fishing as leisure with a simple configuration and a simple configuration. To provide a device that can avoid feeding damage when fishing fish such as tuna, and also to use it during marine leisure such as surfing with a simple configuration, and to avoid human damage caused by sharks etc. It is also effective in protecting human lives by providing equipment that can be used, and can contribute to society.

### BRIEF DESCRIPTION OF THE DRAWINGS

FIG. 1 is a drawing-substituting photograph for explaining an example of an embodiment of the apparatus according to the present invention.

FIG. 2 is a drawing-substituting photograph showing the configuration of a power supply unit of the device according to the present invention.

FIG. 3 is a drawing-substituting photograph for explaining a form of an example of a joint portion of the device according to the present invention.

FIG. 4 is a drawing substitute photograph for explaining an example of a usage pattern of the device according to the present invention.

FIG. 5 is a drawing-substituting photograph for explaining another example of the embodiment of the apparatus according to the present invention.

FIG. 6 is a drawing-substituting photograph for explaining another example of the embodiment of the apparatus according to the present invention.

### DETAILED DESCRIPTION

The present invention is a device that repels organisms that cause human damage or feeding damage such as sharks that live in water, and is provided on a tubular member made of a viscoelastic material and a part of the tubular member. A built-in power supply device, an electrode provided on a part or all of the outer surface of the tubular member, a string-shaped member having a counter electrode extending from the tubular member, and energization from the power supply device. A switch that turns on and off and a joint member that connects the tubular member in a ring shape are provided, and by throwing it into water and applying a voltage and/or current between the electrodes, human damage such as sharks living in water or human damage or It is a device that repels organisms that cause feeding damage, and how to use it.

Further, the present invention is provided in a device for repelling organisms that cause human damage or feeding damage such as sharks living in water, in which a tubular member made of a viscoelastic material and a part of the tubular member are provided. Alternatively, a built-in power supply device, an electrode provided on a part of the outer surface of the tubular member, a counter electrode provided on another part of the outer surface of the tubular member, and energization from the power supply device are applied. A switch that turns on and off and a joint member that connects the tubular member in a ring shape are provided, and by throwing it into water and applying a voltage and/or current between the electrodes, human damage such as sharks living in water or human damage or It is a device that repels organisms that cause feeding damage, and how to use it.

Further, in the present invention, when the device is used to avoid feeding damage when fishing fish such as tuna, the device is stored on the ship in a state where the switch is off and the joint member is not connected. After the fish to be fished such as tuna is caught on the needle, the tube-shaped member is connected by a ring-shaped joint member so as to surround the thread, and the thread is used as a guide to throw the fish into the vicinity of the fish to be fished. To do.

Further, in the present invention, as a material having viscoelasticity used for the tubular member, synthetic resin, silicon resin, natural rubber, synthetic rubber, phenol resin, epoxy resin, melamine resin, urea resin, unsaturated polyester resin, alkyd resin, etc. Thermosetting resins such as polyurethane and thermosetting polyimide, polyethylene, polypropylene, polyvinyl chloride, polyvinylidene chloride, polystyrene, vinyl acetate, polytetrafluoroethylene, ABS resin, AS resin, acrylic resin, polyamide, nylon, polyacetal □E Polycarbonate □E Modified polyphenylene ether □E Polybutylene terephthalate □E Polyethylene terephthalate □E Cyclic polyolefin □E Polyphenylensulfide □E Polytetrafluoroethylene □E Polysulfone □E Polyether sulfone □E Acrylic polyarylate □E Liquid crystal polymer □E Polyether ether ketone □E Thermoplastic polyimide □Elt is characterized by being any one of a thermoplastic resin such as polyamideimide, a mixed material thereof, a composite material of these and a fiber, a glass fiber, and other reinforcing materials, and a composite material including a metal material.

Further, the present invention is characterized in that the size of the ring in a state where the tubular members are connected in a ring shape is 10 cm or more and 60 cm or less. Further, in the present invention, it is desirable that the size of the ring in a state where the tubular members are connected in a ring shape is 15 cm or more and 40 cm or less.

Further, the present invention is characterized in that the joint for connecting the tubular members has a structure in which both ends are fitted to each other. Further, in the present invention, a one-touch joint is preferably used as a joint for connecting the tubular members.

Further, the present invention is characterized in that the joint for connecting the tubular members has a structure of joining with a magnet. Further, in the present invention, a neodymium magnet is preferably used as the magnet used for the joint for connecting the tubular members.

Further, the present invention is characterized in that the length of the string-shaped member provided with the counter electrode extending from the tubular member is 30 cm or more and 3 m or less. Further, in the present invention, it is desirable that the length of the string-shaped member provided with the counter electrode extending from the tubular member is 50 cm or more and 2 m or less.

Further, the present invention is characterized in that the power supply device for applying a voltage between the electrodes includes a battery. Further, in the present invention, a dry battery, a button type battery or a rechargeable storage battery is preferably used as the battery.

Further, the present invention is characterized in that the power supply device included in the device prepares a discharge voltage and discharges it into the sea in order to control an electromagnetic field in water. Further, the present invention is characterized in that the discharge voltage discharged into the sea is a pulse voltage.

Further, the present invention is characterized in that the power supply device included in the device outputs a discharge current into the sea in order to control the electromagnetic field in water. Further, the present invention is characterized in that the discharge voltage discharged into the sea is a pulse current.

Further, the present invention is characterized in that the pattern of the discharge voltage or discharge current discharged into the sea can be changed. Further, the present invention is characterized in that the pattern of the discharge voltage or discharge current discharged in the sea can be changed, and the pattern can be changed in the field at the time of use.

Further, the present invention is characterized in that the pattern changing function is performed by incorporating a function that can be reprogrammed.

Further, the present invention is characterized in that the pattern changing function is performed by installing programmable hardware.

Further, the present invention is characterized in that the pattern changing function is performed by mounting a microcomputer and recorded software and rewriting the program.

The present invention is also characterized in that the discharge voltage or discharge current discharged in the sea is generated by a charge pump or a DC-DC converter. Alternatively, the present invention is characterized in that the pulse width and/or period of the pattern of the discharge voltage or discharge current discharged into the sea is controlled.

Further, the present invention is characterized in that the pulse width and/or period of the pattern of the discharge voltage or discharge current discharged into the sea can be changed.

The present invention is also characterized in that the pattern of the discharge voltage or discharge current discharged into the sea is randomly changed in its pulse width and/or period.

The present invention is also characterized in that the pattern of the discharge voltage or discharge current discharged into the sea has a pulse width of 0.2 seconds or more and 0.7 seconds or less. Further, in the present invention, it is desirable that the period of the pattern of the discharge voltage or the discharge current discharged into the sea is 0.5 seconds or more and 5 seconds or less, and twice or more the discharge pulse width. It is more desirable that the period of the pattern of the discharge voltage or discharge current discharged into the sea is 1 second or more and 4 seconds or less, and twice or more the discharge pulse width.

Further, the present invention is characterized in that the tubular member has translucency, a light emitting element is provided on the circuit, and the internal state can be confirmed by the light emission of the light emitting element. An LED element is preferably used as the light emitting element. Further, the present invention is characterized in that the light emitting element is an LED element and also has a function of notifying the position in an emergency.

Further, the present invention is characterized in that the voltage supplied by the power supply device is 3 V or more and 30 V or less.

Further, the present invention is characterized in that the pulse voltage or pulse current supplied by the power supply device is set so as to also serve as a signal for notifying the position in an emergency. Further, the present invention is characterized in that the pulse voltage or pulse current supplied by the power supply device for applying a voltage between the electrodes is set so as to also serve as a Morse code.

Further, the present invention has a configuration in which a switch for turning on/off the energization from a power supply device for applying a voltage between the electrodes is turned on by connecting a joint for connecting the tubular members. It is a feature.

Further, the present invention is characterized in that a switch for turning on/off the energization from the power supply device for applying a voltage between the electrodes is configured so that the sensor reacts and turns on when the switch is put into water.

Further, in the present invention, when the device is used to avoid feeding damage when fishing fish such as tuna, the main body in which the tubular members are connected in a ring shape is fitted into the head of the target fish after being put into the gill lid. It is characterized by restricting the movement of the target fish and regulating the activity of the target fish.

Further, in the present invention, when the device is used to avoid human damage caused by sharks during marine leisure such as surfing, diving, snorkeling, etc., the device is attached to a user's arm, leg, etc. It is characterized in that it is attached to equipment such as a wet suit or installed on equipment such as a surfboard.

The present invention is a device that repels organisms that cause human damage or feeding damage such as sharks that live in water, and is a power supply device enclosed in a waterproof member and one of the outer surfaces of the waterproof member. It is equipped with a string-shaped member having an electrode provided in a part or all of it, a counter electrode extending from the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

Further, the present invention is a device for repelling organisms that cause human damage or feeding damage such as sharks living in water, in which a power supply device enclosed in a waterproof member and an outer surface of the waterproof member are used. It is equipped with an electrode provided in a part, a counter electrode provided in another part of the outer surface of the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

Further, the present invention is a device for repelling an organism that causes human damage or feeding damage such as a shark that lives in water. The power supply device is sealed with a molding agent, and even when it is put into water, it is contained in water. It is characterized by not touching.

Further, in the present invention, as a material having viscoelasticity used for the tubular member, synthetic resin, silicon resin, natural rubber, synthetic rubber, phenol resin, epoxy resin, melamine resin, urea resin, unsaturated polyester resin, alkyd resin, etc. Thermosetting resins such as polyurethane and thermosetting polyimide, polyethylene, polypropylene, polyvinyl chloride, polyvinylidene chloride, polystyrene, vinyl acetate, polytetrafluoroethylene, ABS resin, AS resin, acrylic resin, polyamide, nylon, polyacetal □E Polycarbonate □E Modified polyphenylene ether □E Polybutylene terephthalate □E Polyethylene terephthalate □E Cyclic polyolefin □E Polyphenylensulfide □E Polytetrafluoroethylene □E Polysulfone □E Polyether sulfone □E Acrylic polyarylate □E Liquid crystal polymer □E Polyether ether ketone □E Thermoplastic polyimide □EIt is characterized by being any one of a thermoplastic resin such as polyamideimide, a mixed material thereof, a composite material of these and a fiber, a glass fiber, and other reinforcing materials, and a composite material including a metal material.

Further, the present invention is characterized in that the molding agent is injected and formed so as not to leave air bubbles or voids between the molding agent and the power supply device enclosed inside.

Further, the present invention is characterized in that the material used for the waterproof member is formed by injection molding.

Further, the present invention is characterized in that the length of the string-shaped member provided with the counter electrode extending from the tubular member is 30 cm or more and 3 m or less. Further, in the present invention, it is desirable that the length of the string-shaped member provided with the counter electrode extending from the tubular member is 50 cm or more and 2 m or less.

Further, the present invention is characterized in that the power supply device for applying a voltage between the electrodes includes a battery. Further, in the present invention, a dry battery, a button type battery or a rechargeable storage battery is preferably used as the battery.

Further, the present invention is characterized in that the power supply device included in the device prepares a discharge voltage and discharges it into the sea in order to control an electromagnetic field in water. Further, the present invention is characterized in that the discharge voltage discharged into the sea is a pulse voltage.

Further, the present invention is characterized in that the power supply device included in the device outputs a discharge current into the sea in order to control the electromagnetic field in water. Further, the present invention is characterized in that the discharge voltage discharged into the sea is a pulse current.

Further, the present invention is characterized in that the pattern of the discharge voltage or discharge current discharged into the sea can be changed. Further, the present invention is characterized in that the pattern of the discharge voltage or discharge current discharged in the sea can be changed, and the pattern can be changed in the field at the time of use.

Further, the present invention is characterized in that the pattern changing function is performed by incorporating a function that can be reprogrammed.

Further, the present invention is characterized in that the pattern changing function is performed by installing programmable hardware.

Further, the present invention is characterized in that the pattern changing function is performed by mounting a microcomputer and recorded software and rewriting the program.

The present invention is also characterized in that the discharge voltage or discharge current discharged in the sea is generated by a charge pump or a DC-DC converter. Alternatively, the present invention is characterized in that the pulse width and/or period of the pattern of the discharge voltage or discharge current discharged into the sea is controlled.

Further, the present invention is characterized in that the pulse width and/or period of the pattern of the discharge voltage or discharge current discharged into the sea can be changed.

The present invention is also characterized in that the pattern of the discharge voltage or discharge current discharged into the sea is randomly changed in its pulse width and/or period.

The present invention is also characterized in that the pattern of the discharge voltage or discharge current discharged into the sea has a pulse width of 0.2 seconds or more and 0.7 seconds or less. Further, in the present invention, it is desirable that the period of the pattern of the discharge voltage or the discharge current discharged into the sea is 0.5 seconds or more and 5 seconds or less, and twice or more the discharge pulse width. It is more desirable that the period of the pattern of the discharge voltage or discharge current discharged into the sea is 1 second or more and 4 seconds or less, and twice or more the discharge pulse width.

Further, the present invention is characterized in that the pulse voltage or pulse current supplied by the power supply device is set so as to also serve as a signal for notifying the position in an emergency. Further, the present invention is characterized in that the pulse voltage or pulse current supplied by the power supply device for applying a voltage between the electrodes is set so as to also serve as a Morse code.

Further, the present invention is characterized in that the switch for turning on/off the energization from the power supply device has a configuration in which the sensor reacts and turns on when the switch is put into water.

Further, in the present invention, when the device is used to avoid human damage caused by sharks during marine leisure such as surfing, diving, snorkeling, etc., the device is attached to a user's arm, leg, etc. It is characterized in that it is attached to equipment such as a wet suit or installed on equipment such as a surfboard.

Further, the present invention is characterized in that the waterproof member and the mold member have translucency, and a light emitting element is provided on the circuit, and the internal state can be confirmed by the light emission of the light emitting element. . . . An LED element is preferably used as the light emitting element. Further, the present invention is characterized in that the light emitting element is an LED element and also has a function of notifying the position in an emergency.

Further, in the present invention, the waterproof member has a substantially cylindrical shape with one end formed into a substantially dome shape, and is used together with fishing gear, fishing gear, etc., or for a body, wet suit, life jacket, marine leisure equipment, etc. It is characterized by being attached and used. Further, the present invention is characterized in that the waterproof member is formed in a disk shape and has a belt, and is worn and used like a wristwatch during marine leisure.

The device and its usage method for repelling organisms that cause human damage or feeding damage such as sharks living in water according to the present invention can be used in fishing as leisure with a simple configuration and a simple configuration. To provide a device that can avoid feeding damage when fishing fish such as tuna, and also to use it during marine leisure such as surfing with a simple configuration, and to avoid human damage caused by sharks etc. It is also effective in protecting human lives by providing equipment that can be used, and can contribute to society.

### DESCRIPTION OF PREFERRED EMBODIMENTS

### Example 1

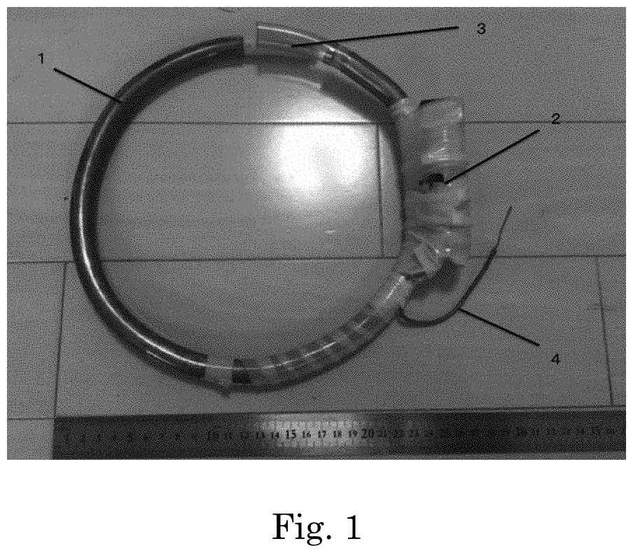

Hereinafter, an example of implementation of a device for repelling organisms that cause human damage or feeding damage such as sharks living in water and a method of using the device according to the present invention will be described with reference to the drawings. FIG. 1 is a drawing-substituting photograph for explaining an example of an embodiment of the apparatus according to the present invention. This embodiment is a device that repels organisms that cause human damage or feeding damage such as sharks that live in water, and is provided on a tubular member made of a viscoelastic material and a part of the tubular member. Alternatively, a built-in power supply device, an electrode provided on a part or all of the outer surface of the tubular member, a string-shaped member having a counter electrode extending from the tubular member, and energization from the power supply device. A switch for turning on and off and a joint member for connecting the tube-shaped member in a ring shape are provided, and by putting the tube-shaped member into water and applying a voltage and/or current between the electrodes, human damage such as a shark inhabiting the water is caused. Alternatively, it is a device that repels organisms that cause feeding damage, and is a method of using the device.

FIG. 1 shows a prototype state of the device according to the present invention. It goes without saying that the present invention is not limited to such a form. Here, in the present embodiment, a mode in which the apparatus according to the invention is used to avoid feeding damage during fishing of fish such as tuna will be described.

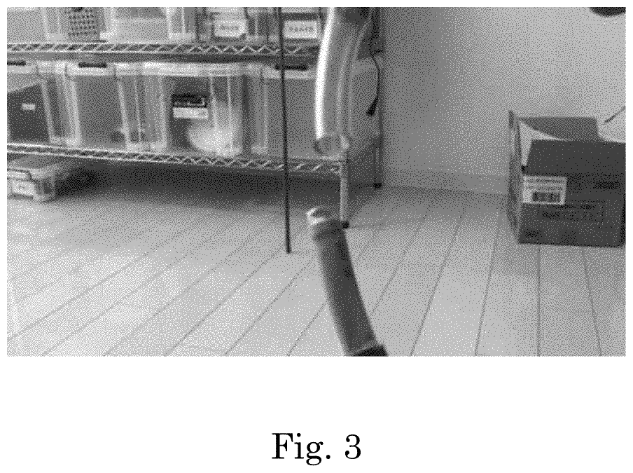

In using the device according to the present invention to avoid feeding damage when fishing fish such as tuna, the device is stored on board the ship in a state where the switch is off and the joint member is not connected. After the fish to be fished such as tuna is caught on the needle, the tube-shaped member is connected by a ring-shaped joint member so as to surround the thread, and the thread is used as a guide to throw it into the vicinity of the fish to be fished. FIG. 3 shows a drawing-substituting photograph for explaining a form of an example of a joint portion of the device according to the present invention.

In FIG. 1, a tubular member 1 made of a viscoelastic material forms a main body. The materials with viscoelasticity used for the tubular member are synthetic resin, silicon resin, natural rubber, synthetic rubber, phenol resin, epoxy resin, melamine resin, urea resin, unsaturated polyester resin, alkyd resin, polyurethane, and thermosetting polyimide. Thermosetting resins such as polyethylene, polypropylene, polyvinyl chloride, polyvinylidene chloride, polystyrene, polyvinyl acetate, polytetrafluoroethylene, ABS resin, AS resin, acrylic resin, polyamide, nylon, polyacetal, polycarbonate, modified polyphenylene ether □E Polybutylene terephthalate □E Polyethylene terephthalate □E Cyclic polyolefin □E Polyphenylensulfide □E Polytetrafluoroethylene □E Polysulfone □E Polyether sulfone □E Acrylic polyarylate □E Liquid crystal polymer □E Polyether ether ketone □E Thermoplastic polyimide Any of a resin, a mixed material thereof, a composite material of these and a fiber, a glass fiber, and other reinforcing materials, and a composite material including a metal material is preferably used.

Here, in addition to using the material forming the main body in a ring shape, the material is damaged by friction with the fishing rod when the fishing rod is used as a guide and thrown into the vicinity of the fish to be fished. It is necessary to avoid the problem, and it is desirable to select from the above-mentioned material group.

In this embodiment, the size of the ring in the state where the tube-shaped members are connected in a ring shape is formed to be about 23 cm. Here, it is desirable that the size of the ring when the tube-shaped members are connected in a ring shape is 10 cm or more and 60 cm or less, and further, the size of the ring when the tube-shaped members are connected in a ring shape is 15 cm. It is desirable that it is 40 cm or more and 40 cm or less. This is effective for the target fish, and when the device is used to avoid feeding damage when fishing fish such as tuna, the main body in which the tubular members are connected in a ring shape is attached to the head of the target fish after being put in. This is because the fitting limits the movement of the gill lid and also has the effect of regulating the activity of the target fish.

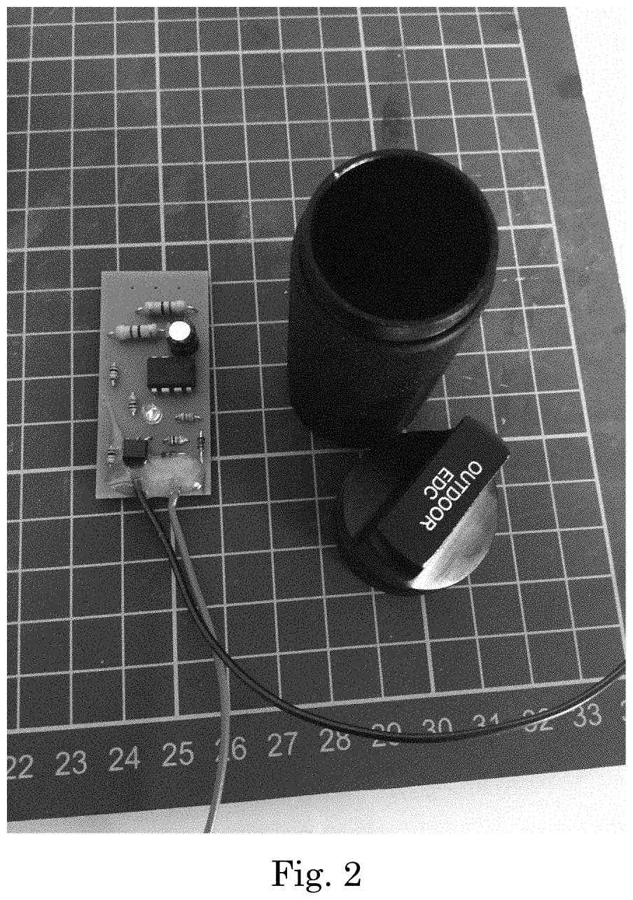

In this embodiment, a dry battery is built in the power supply unit 2 as a power source, and a circuit for generating a pulse voltage is also built in and used. FIG. 2 shows a drawing substitute photograph showing the configuration of the power supply unit. The right side in the figure is the battery case, which was used for the power supply unit 2 of the main body together with the power supply circuit on the left side. Here, this embodiment is an experimental prototype, and in an actual product, it may be built in the main body 1 after miniaturization.

In the present invention, the joints for connecting the tubular members have a structure in which both ends are fitted to each other. As a result, the switch is turned off and the joint member is not connected on the ship, and after the fish to be fished such as tuna is caught by the needle, the tube-shaped member is ring-shaped so as to surround the thread. It is possible to connect the fish to the vicinity of the fish to be fished by using the thread as a guide.

Here, in the present invention, it is also effective to have a structure in which joints for connecting tubular members are joined by magnets. In particular, by using a neodymium magnet or the like having a strong magnetic force, it is possible to obtain by superimposing a repellent effect such as a shark by a magnetic field as well as an electric current, and the effect can be increased.

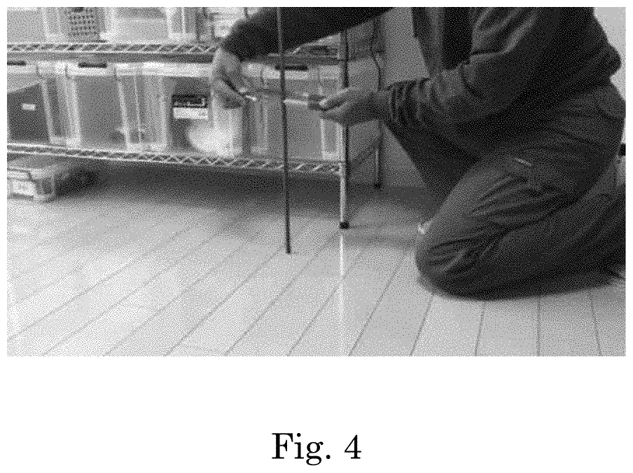

FIG. 4 is a drawing substitute photograph for explaining an example of a usage pattern of the device according to the present invention. By connecting the tubular members so as to surround the rod that looks like a road thread, it is possible to use the road thread as a guide and throw it into the vicinity of the fish to be fished.

In the present invention, it is desirable that the length of the string-shaped member provided with the counter electrode extending from the tubular member is 30 cm or more and 3 m or less, and further, the counter electrode extending from the tubular member is provided. It is desirable that the length of the string-shaped member is 50 cm or more and 2 m or less. This is determined by the size of the target fish, the repellent effect, and the effective time of the power supply. By using the counter electrode extending in these ranges, it is effective even in a large target fish such as tuna, and a sufficient duration can be obtained.

In the present invention, it is desirable that the power supply device for applying a voltage between the electrodes includes a battery, and further, it is desirable that the battery is a dry battery, a button type battery, or a storage battery capable of charging and discharging. By using these, power transmission from the ship becomes unnecessary, and a device that can be easily used for leisure is realized.

The present invention is characterized in that the power supply device included in the device prepares a discharge voltage and discharges it into the sea in order to control an electromagnetic field in water. Further, in the present invention, the discharge voltage discharged into the sea is set to be a pulse voltage. As a result, it is possible to construct a device that can withstand long-term use by suppressing the amount of attenuation of the battery due to discharge in seawater.

Here, in the present invention, the power supply device included in the device may output a discharge current into the sea in order to control the electromagnetic field in water. In this case, the discharge current discharged into the sea may be a pulse current. As a result, it is possible to construct a device that can withstand long-term use by suppressing the amount of attenuation of the battery due to discharge in seawater.

In this embodiment, the pattern of the discharge voltage or discharge current discharged into the sea can be changed. Further, it is more desirable that the pattern of the discharge voltage or discharge current discharged in the sea can be changed, and the pattern can be changed in the field at the time of use.

This prevents the target organism from becoming accustomed to the electromagnetic field pattern in water and diminishing its effect, ensuring continuous effectiveness.

The pattern change function is realized by installing a function that can be reprogrammed. Specifically, it is performed by installing programmable hardware or installing a microcomputer and recorded software and rewriting the program.

The discharge voltage or discharge current discharged into the sea is generated by a charge pump or DC-DC converter. The pulse width and/or period of the discharge voltage or discharge current pattern discharged into the sea is controlled.

It is also effective that the pattern of the discharge voltage or discharge current discharged in the sea is randomly changed in its pulse width and/or period. This also prevents the target organism from becoming accustomed to the electromagnetic field pattern in water and diminishing its effect, and ensures continuous effectiveness.

It is desirable that the pattern of the discharge voltage or discharge current discharged into the sea has a pulse width of 0.2 seconds or more and 0.7 seconds or less. Further, it is desirable that the period of the discharge voltage or discharge current pattern discharged into the sea is 0.5 seconds or more and 5 seconds or less, and the discharge pulse width is twice or more, and the discharge discharged into the sea. It is more desirable that the period of the voltage or discharge current pattern is 1 second or more and 4 seconds or less, and twice or more the discharge pulse width. By using the battery in such a range, it is possible to construct a device that can withstand long-term use by suppressing the amount of attenuation of the battery due to discharge in water without impairing the repellent effect.

When the effect was confirmed in actual fishing using the device according to the present invention, about 80% of the tuna fishing was usually damaged by feeding damage, but the use of this device caused 10% of the feeding damage. It was found to be dramatically effective, with less than a degree. The same effect was confirmed in the goldfish fishing.

In the present invention, a switch for turning on/off the energization from the power supply device for applying a voltage between the electrodes can be turned on by connecting a joint for connecting the tubular member. It was valid. As a result, it was possible to shift to the used state without requiring any switch operation. It is also effective to configure the sensor to react and turn on when a switch for turning on/off the energization from the power supply device for applying a voltage between the electrodes is put into water. In this case, a sensor or the like that detects that the resistance value changes when the substance is put into water is preferably used.

### Example 2

Next, an example in which the device according to the present invention is used to avoid human damage caused by sharks and the like during marine leisure such as surfing will be described. The device according to the present invention causes human damage or feeding damage such as sharks living in water by attaching it to the user's arm, leg, etc., attaching it to equipment such as a life jacket, or installing it on an instrument such as a surfboard. Can repel living things.

In the case of such a usage method, it is particularly desirable that the size of the ring when the tube-shaped members are connected in a ring shape is 10 cm or more and 60 cm or less, and further, the size of the ring when the tube-shaped members are connected in a ring shape. It is desirable that the size is 15 cm or more and 45 cm or less. This is because it is convenient to be attached to the user's arm, leg, etc., and it is suitable for installation and use in an instrument such as a surfboard.

Further, in the case of such a usage method, it is desirable that the length of the string-shaped member provided with the counter electrode extending from the tubular member is 20 cm or more and 2 m or less, and further, the counter electrode extending from the tubular member is provided. It is desirable that the length of the string-shaped member is 35 cm or more and 1 m 50 cm or less. This is to secure a necessary and sufficient electric field range in consideration of the physique of the user and the size of equipment such as a surfboard.

In the case of such usage, it is effective that the switch that turns on and off the energization is configured so that the sensor reacts and turns on when it is put into water. This is because there is a risk of harm from sharks and the like if the user falls into the water. In addition, since the switch is turned off before the water falls, it has the effect of extending the usage time and the standby time.

Further, in the case of such usage, the pulse voltage or pulse current supplied by the power supply device can be set so as to also serve as a signal for notifying the position in an emergency, and particularly by a power supply device for applying a voltage between the electrodes. By setting the supplied pulse voltage or pulse current to also serve as a Morse signal, there is an effect of contributing to a search or the like in an emergency.

Further, in the case of such a usage method, by including a light emitting element for notifying the position in an emergency, there is an effect of contributing to the search etc. in an emergency. In this case, it is preferable to use an LED as a light emitting element because of power consumption.

### Example 3

Next, another example of the implementation of the device for repelling human damage or feeding damage such as sharks living in water and the method of using the device according to the present invention will be described with reference to the drawings. 5 and 6 are drawing-substituting photographs for explaining another example of the embodiment of the apparatus according to the present invention. The present invention is a device that repels organisms that cause human damage or feeding damage such as sharks that live in water, and is a power supply device enclosed in a waterproof member and one of the outer surfaces of the waterproof member. It is equipped with a string-shaped member having an electrode provided in a part or all of it, a counter electrode extending from the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

Further, the present invention is a device for repelling organisms that cause human damage or feeding damage such as sharks living in water, in which a power supply device enclosed in a waterproof member and an outer surface of the waterproof member are used. It is equipped with an electrode provided in a part, a counter electrode provided in another part of the outer surface of the waterproof member, and a switch for turning on/off the electric current from the power supply device. It is a device that repels organisms that cause human damage or feeding damage such as sharks that live in water by attaching a voltage and/or current between the electrodes by attaching it to a leisure device or the like, and how to use it. Is.

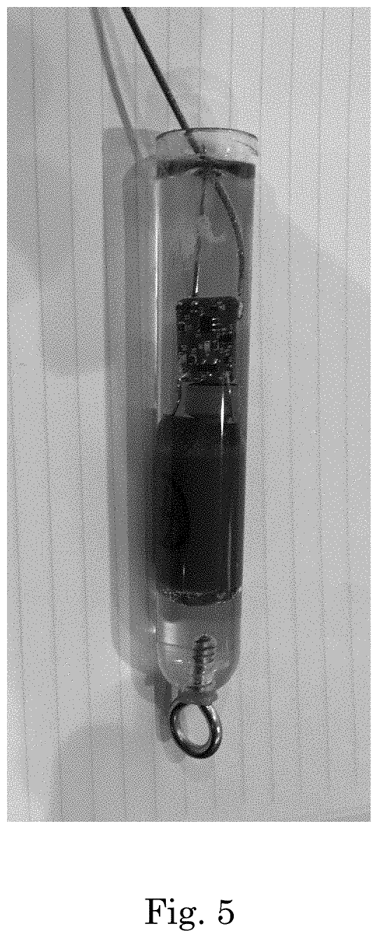

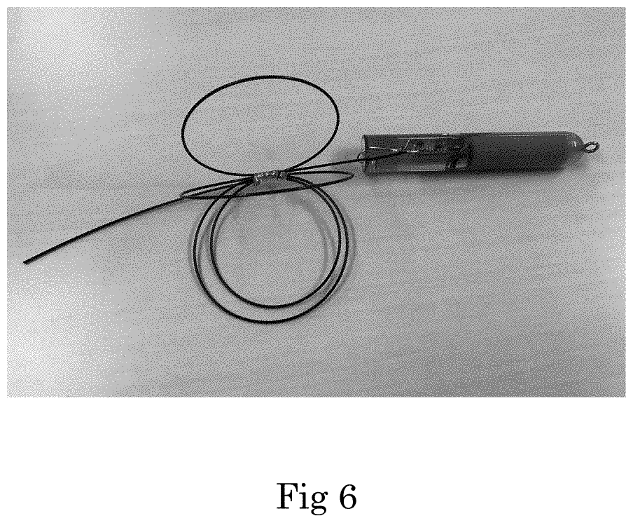

FIGS. 5 and 6 show a prototype state of the apparatus according to the present invention. It goes without saying that the present invention is not limited to such a form. Here, the mode in which the apparatus according to the present invention is used to avoid feeding damage when fishing fish such as tuna is almost the same as in the case of Example 1.

In this embodiment, the waterproof member has a substantially cylindrical shape with one end formed into a substantially dome shape, and is used together with fishing gear, fishing gear, etc., or a body, wet suit, life jacket, marine leisure equipment. It was used by attaching it to the like. It is also effective that the waterproof member is formed in a disk shape and has a belt, and is worn and used like a wristwatch during marine leisure.

In FIGS. 5 and 6, the waterproof members are synthetic resin, silicon resin, natural rubber, synthetic rubber, phenol resin, epoxy resin, melamine resin, urea resin, unsaturated polyester resin, alkyd resin, polyurethane, and thermosetting. Thermosetting resins such as thermoplastic, polyethylene, polypropylene, polyvinyl chloride, polyvinylidene chloride, polystyrene, vinyl acetate, polytetrafluoroethylene, ABS resin, AS resin, acrylic resin, polyamide, nylon, polyacetal, polycarbonate, modified Polyphenylene ether, polybutylene terephthalate, polyethylene terephthalate, cyclic polyolefin, polyphenylen sulphide, polytetrafluoroethylene, polysulfone, polyether sulfone, amorphous polyarylate, liquid crystal polymer, polyether ether ketone, thermoplastic polyimide, polyamideimide, etc. Any of a thermoplastic resin, a mixed material thereof, a composite material of these and a fiber, a glass fiber, and other reinforcing materials, and a composite material including a metal material is preferably used.

In the present invention, it is desirable that the length of the string-shaped member having the counter electrode extending from the power supply device is 30 cm or more and 3 m or less, and further, the string-shaped member having the counter electrode extending from the power supply device is provided. It is desirable that the length of the member is 50 cm or more and 2 m or less. In FIG. 6, a string-shaped member provided with such a counter electrode is shown in a bundle, and the length thereof can be confirmed. This is determined by the size of the target fish, the repellent effect, and the effective time of the power supply. By using the counter electrode extending in these ranges, it is effective even in a large target fish such as tuna, and a sufficient duration can be obtained.

In the present invention, it is desirable that the power supply device for applying a voltage between the electrodes includes a battery, and further, it is desirable that the battery is a dry battery, a button type battery, or a storage battery capable of charging and discharging . . . . By using these, power transmission from the ship is not required, and a device that can be easily used for leisure is realized.

In the present invention, it is desirable that the power supply device for applying a voltage between the electrodes includes a battery, and further, it is desirable that the battery is a dry battery, a button type battery, or a storage battery capable of charging and discharging. . . . By using these, power transmission from the ship becomes unnecessary, and a device that can be easily used for leisure is realized.

The present invention is characterized in that the power supply device included in the device prepares a discharge voltage and discharges it into the sea in order to control an electromagnetic field in water. Further, in the present invention, the discharge voltage discharged into the sea is set to be a pulse voltage. As a result, it is possible to construct a device that can withstand long-term use by suppressing the amount of attenuation of the battery due to discharge in seawater.

Here, in the present invention, the power supply device included in the device may output a discharge current into the sea in order to control the electromagnetic field in water. In this case, the discharge current discharged into the sea may be a pulse current. As a result, it is possible to construct a device that can withstand long-term use by suppressing the amount of attenuation of the battery due to discharge in seawater.

In this embodiment, the pattern of the discharge voltage or discharge current discharged into the sea can be changed. Further, it is more desirable that the pattern of the discharge voltage or discharge current discharged in the sea can be changed, and the pattern can be changed in the field at the time of use.

This prevents the target organism from becoming accustomed to the electromagnetic field pattern in water and diminishing its effect, ensuring continuous effectiveness.

The pattern change function is realized by installing a function that can be reprogrammed. Specifically, it is performed by installing programmable hardware or installing a microcomputer and recorded software and rewriting the program.

The discharge voltage or discharge current discharged into the sea is generated by a charge pump or DC-DC converter. The pulse width and/or period of the discharge voltage or discharge current pattern discharged into the sea is controlled.

It is also effective that the pattern of the discharge voltage or discharge current discharged in the sea is randomly changed in its pulse width and/or period. This also prevents the target organism from becoming accustomed to the electromagnetic field pattern in water and diminishing its effect, and ensures continuous effectiveness.

It is desirable that the pattern of the discharge voltage or discharge current discharged into the sea has a pulse width of 0.2 seconds or more and 0.7 seconds or less. Further, it is desirable that the period of the discharge voltage or discharge current pattern discharged into the sea is 0.5 seconds or more and 5 seconds or less, and the discharge pulse width is twice or more, and the discharge discharged into the sea. It is more desirable that the period of the voltage or discharge current pattern is 1 second or more and 4 seconds or less, and twice or more the discharge pulse width. By using the battery in such a range, it is possible to construct a device that can withstand long-term use by suppressing the amount of attenuation of the battery due to discharge in water without impairing the repellent effect.

When the effect was confirmed in actual fishing using the device according to the present invention, about 80% of the tuna fishing was usually damaged by feeding damage, but the use of this device caused 10% of the feeding damage. It was found to be dramatically effective, with less than a degree. The same effect was confirmed in the goldfish fishing.

In the present invention, it is also effective to configure the sensor to react and turn on when a switch for turning on/off the energization from the power supply device for applying a voltage between the electrodes is put into water. is there. In this case, a sensor or the like that detects that the resistance value changes when the substance is put into water is preferably used.

### Example 4

Next, an example in which the device according to the present invention is used to avoid human damage caused by sharks and the like during marine leisure such as surfing will be described. The device according to the present invention causes human damage or feeding damage such as sharks living in water by attaching it to the user's arm, leg, etc., attaching it to equipment such as a life jacket, or installing it on an instrument such as a surfboard. Can repel living things.

In the case of such a usage method, it is particularly preferable to attach the power supply unit to the vicinity of the head and shoulders of the wet suit and fix the string-shaped electrodes to the legs, flippers, ankles, wrists, etc. It can also be suitably used by installing it on an instrument such as a surfboard.

Further, in the case of such a usage method, it is desirable that the length of the string-shaped member having the counter electrode extending from the power supply device is 20 cm or more and 2 m or less, and further, the string provided with the counter electrode extending from the power supply device. It is desirable that the length of the shaped member is 35 cm or more and 1 m 50 cm or less. This is to secure a necessary and sufficient electric field range in consideration of the physique of the user and the size of equipment such as a surfboard.

In the case of such usage, it is effective that the switch that turns on and off the energization is configured so that the sensor reacts and turns on when it is put into water. This is because there is a risk of harm due to sharks, etc. when the user falls or enters the water. In addition, since the switch is turned off before the water falls, it has the effect of extending the usage time and the standby time.

Further, in the case of such usage, the pulse voltage or pulse current supplied by the power supply device can be set so as to also serve as a signal for notifying the position in an emergency, and particularly by a power supply device for applying a voltage between the electrodes. By setting the supplied pulse voltage or pulse current to also serve as a Morse signal, there is an effect of contributing to a search or the like in an emergency.

Further, in the case of such a usage method, by including a light emitting element for notifying the position in an emergency, there is an effect of contributing to the search etc. in an emergency. In this case, it is preferable to use an LED as a light emitting element because of power consumption.

### INDUSTRIAL APPLICABILITY

As described above, the device for repelling human-damaged or feeding-damaging organisms such as sharks living in water and the method of using the device according to the present invention have a simple structure and a simple structure for fishing as leisure. It can be used even if it is used, and it provides a device that can avoid feeding damage when fishing fish such as tuna, and it can also be used during marine leisure such as surfing with a simple configuration. It provides a device that can avoid damage to humans, is effective in protecting human lives, and has great industrial applicability.

### EXPLANATION OF SYMBOLS

1 Tube-shaped member made of viscoelastic material
2 Power supply
3 Joint part
4 Opposite electrode

1. A device that repels organisms that cause human harm under underwater activities, comprising:
a tubular member made of a viscoelastic material and a power supply device provided or built in a part of the tubular member,
electrodes provided on a part or all of the outer surface of the tubular member,
a string-shaped member having a counter electrode extending from the tubular member and a switch that turns on and off the power supply from the power supply,
a joint member for connecting the tubular member in a ring shape is provided by putting the joint member in water and applying one or more of a voltage or current between the electrodes to repel organisms, that cause human harm.

2. The device of claim 1, wherein the joint member for connecting the tubular members has a structure in which both ends are fitted to each other.

3. The device of claim 1, wherein the joint member for connecting the tubular members has a structure in which it is joined by a magnet.

4. The device of claim 1, wherein the power supply device has a discharge voltage which is prepared and discharged into the sea in order to control an electromagnetic field in water.

5. The device of claim 1, wherein the power supply device included in the device prepares a discharge voltage and discharges it into the sea in order to control the electromagnetic field in water, and the discharge voltage discharged into the sea is a pulse voltage.

6. The device of claim 1, wherein the power supply device included in the device outputs a discharge current into the sea in order to control an electromagnetic field in the water.

7. The device of claim 1, wherein the power supply device included in the device outputs a discharge current into the sea in order to control the electromagnetic field in the water, and the discharge current discharged into the sea is a pulse current.

8. The device of claim 1, wherein the discharge voltage or discharge current discharged into the sea is has a pattern that is changeable.

9. The device of claim 1, wherein a pattern associated with the discharge voltage or discharge current discharged into the sea changeable, and a pattern change function in the device is equipped with a reprogrammable function.

10. The device of claim 1, wherein a pattern associated with the discharge voltage or discharge current discharged into the sea is changeable, and a pattern change function in the device is equipped with programmable hardware.

11. The device of claim 1, wherein a pattern associated with the discharge voltage or discharge current discharged into the sea is changeable, a pattern change function in the device is equipped with a microcomputer and recorded software that is re-configurable.

12. The device of claim 1, wherein the discharge voltage or discharge current discharged into the sea is generated by a charge pump or a DC-DC converter.

13. The device of claim 1, wherein a pattern associated with the discharge voltage or discharge current discharged into the sea is changeable, and the pattern of the discharge voltage or discharge current discharged into the sea is one or more of a pulse width or a period.

14. The device of claim 1, wherein a pattern associated with the discharge voltage or discharge current discharged into the sea is changeable, and the pattern of the discharge voltage or discharge current discharged into the sea is one or more of a pulse width or a period, which are randomly changed.

15. The device of claim 1, wherein a pattern associated with the discharge voltage or discharge current discharged into the sea is changeable, and the pattern of the discharge voltage or discharge current discharged into the sea has a pulse width that is 0.2 seconds or more and 0.7 seconds or less.

16. The device of claim 1, wherein a pattern associated with the discharge voltage or discharge current discharged into the sea is changeable, and the pattern of the discharge voltage or discharge current discharged into the sea has a period of 0.5 seconds or more and 5 seconds or less, and the period is twice or more a discharge pulse width.

17. The device of claim 1, wherein the tubular member has translucency and is equipped with a light emitting element on the circuit, and the internal state can be confirmed by the light emission of the light emitting element.

18. The device of claim 1, wherein the switch that turns on/off the energization from the power supply device for applying voltage between the electrodes is turned on by connecting joints for connecting the tubular members.

19. The device of claim 1, wherein the switch that turns on/off the energization from the power supply device for applying voltage between the electrodes is a sensor which reacts and turns on when the sensor enters the water.

20. The device of claim 1, in which the device is used to avoid feeding damage when fishing, a main body in which the tubular members is connected in a ring shape in that the movement of the gill lid is restricted by fitting the tube-shaped member into a head of a target fish after being thrown in, and the activity of the target fish is regulated.

21. The device of claim 1, in which the device is used to avoid human harm caused by dangerous creatures during marine leisure including surfing, diving, snorkeling and swimming, the device is attached to the user's arm or leg, attached to equipment, or installed on an instrument.

22. A device that repels organisms causing human harm, comprising:
a power supply unit enclosed in a waterproof member and electrodes provided on a part or all of an outer surface of the waterproof member and a string-shaped member having a counter electrode extending from the waterproof member,
a switch for turning on/off the power supply from the power supply device is provided by putting the switch in water and applying one or more of a voltage or current between the electrodes to repel organisms that cause human harm.

23. The device of claim 22, wherein the power supply is encapsulated with a molding agent which prevents the power supply from contacting the water even when the power supply is put into the water.

24. The device of claim 22, wherein the power supply device included in the device includes a discharge voltage that is prepared and discharged into the sea in order to control an electromagnetic field in the water.

25. The device of claim 22, wherein the power supply device included in the device prepares a discharge voltage and discharges it into the sea in order to control the electromagnetic field in the water, and the discharge voltage discharged into the sea is a pulse voltage.

26. The device of claim 22, wherein the power supply device included in the device outputs a discharge current into the sea in order to control an electromagnetic field in the water.

27. The device of claim 22, wherein the power supply device included in the device outputs a discharge current into the sea in order to control the electromagnetic field in water, and the discharge current discharged into the sea is a pulse current.

28. The device of claim 22, wherein the discharge voltage or discharge current discharged into the sea has a changeable pattern.

29. The device of claim 22, wherein a pattern associated with the discharge voltage or discharge current discharged into the sea is changeable, and a pattern change function of the device is equipped with a reprogrammable function.

30. The device of claim 22, wherein a pattern associated with the discharge voltage or discharge current discharged into the sea is changeable, and a pattern change function in the device is equipped with programmable hardware.

31. The device of claim 22, wherein a pattern associated with the discharge voltage or discharge current discharged into the sea is changeable, and a pattern change function in the device is equipped with a microcomputer and recorded software that is re-configurable.

32. The device of claim 22, wherein the discharge voltage or discharge current discharged into the sea is generated by a charge pump or a DC-DC converter.

33. The device of claim 22, wherein a pattern associated with the discharge voltage or discharge current discharged into the sea is changeable, and the pattern of the discharge voltage or discharge current discharged into the sea that is changeable is one or more of a pulse width or a period.

34. The device of claim 22, wherein a pattern associated with the discharge voltage or discharge current discharged into the sea is changeable, and the pattern of the discharge voltage or discharge current discharged into the sea that is changeable is one or more of a pulse width or a period that are randomly changed.

35. The device of claim 22, wherein a pattern associated with the discharge voltage or discharge current discharged into the sea is changeable, and the pattern of the discharge voltage or discharge current discharged into the sea has a pulse width of 0.2 seconds or more and 0.7 seconds or less.

36. The device of claim 22, wherein a pattern associated with the discharge voltage or discharge current discharged into the sea is changeable, and the pattern of the discharge voltage or discharge current discharged into the sea has a period of 0.5 seconds or more and 5 seconds or less, and the period is twice or more a discharge pulse width.

37. The device of claim 22, wherein a member in which the power supply device is sealed with a molding agent has translucency and is transparent, and it is equipped with a light emitting element on the circuit, and the internal state is confirmable by the light emission of the light emitting element.

39. The device of claim 22, wherein the switch that turns on/off the energization from the power supply device for applying voltage between the electrodes is the sensor which reacts and turns on when it encounters the water.

40. The device of claim 22, wherein the device is used to avoid human harm caused by fish during marine activities, in which the device is attached to the user's arm or leg, attached to equipment including a life jacket or wet suit, or installed on an instrument including a surfboard.

41. The device of claim 22, wherein a waterproof member on one end has a substantially cylindrical shape formed into a substantially dome shape, the waterproof member is used together with fishing gear, or attached to the body, wet suit, life jacket, or marine leisure equipment.

42. The device of claim 22, wherein a waterproof member is molded into a disk shape and equipped with a belt, and it is worn and used like a wristwatch during marine leisure.
